(19) United States
(12) Patent Application Publication
(10) Pub. No.: US 2020/0353945 A1
(43) Pub. Date: Nov. 12, 2020

(54) SAFE RIDING SYSTEM FOR BICYCLES AND ELECTRIC SCOOTERS

(71) Applicants: Demetrius Thompson, Beverly Hills, CA (US); Janet Schijns, Ocean Ridge, FL (US)

(72) Inventors: Demetrius Thompson, Beverly Hills, CA (US); Janet Schijns, Ocean Ridge, FL (US)

(21) Appl. No.: 16/406,770

(22) Filed: May 8, 2019

(51) Int. Cl. B60W 50/14; G08G 1/0962; G08G 1/16; B60W 30/08; B60W 40/06; B60W 40/04

(52) U.S. Cl. CPC B60W 50/14; G08G 1/09623; G08G 1/163; B60W 30/08; B60W 2550/10; B60W 40/06; B60W 40/04; B60W 2050/143; B62K 2202/00; G08G 1/166

(57) ABSTRACT

A method for improving safety for the rider on a bicycle or electric scooter by fitting it with a device capable of receiving a signal that indicates a potentially dangerous location is near. A computer program determines the current location of the bicycle or scooter, whether it is moving, if there is a signal indicative of a potentially dangerous location, and if the bicycle or electric scooter is within a predetermined distance from the potentially dangerous location, whereupon it sounds an alarm. The potentially dangerous location can be a traffic light, a school zone, a railway crossing, a stop sign, a yield sign, or a bridge. In a particular embodiment, the device is a wireless communication device having an active voice mode. The program must determine that wireless communication device is in an active voice mode before sounding the alarm.

### FIELD OF THE INVENTION

The invention relates to a system for ensuring safe riding of bicycles and electric scooters.

### BACKGROUND OF THE INVENTION

Use of bicycles and electric scooters in metropolitan areas have soared in the face of rising fuel prices and by the creation of bicycle lanes in traffic-congested municipalities. Riding a bicycle or electric scooter while approaching certain potentially hazardous locations can be dangerous, exacerbated by the rising number of bicycles and electric scooters on city roads. This is particularly so when distracted, for example when talking on a phone or listening to music or to radio stations through an in-ear phone that communicates by blue tooth with a mobile phone carried by the user, ear buds or headphones, or otherwise being distracted. Hazardous locations include nearby traffic lights, school zones, and railway crossings. When driving a car, significant solutions can be found in U.S. Pat. Nos. 7,308,247 and 7,986,934, each tilted “Cellular Telephone Safety System,” and in U.S. Pat. No. 9,568,334, titled “Safe driving system generating map points,” which together describe detecting when a traffic signal is near or when approaching a school zone or railway crossing while a wireless communication device is in use and issuing an alarm. The alarm warns that a traffic light is red or is calculated to be red by the time the vehicle reaches an intersection, or when the vehicle is approaching a school zone or a railway crossing. Information about the location of traffic lights, school zones, and railway crossings are available as GPS points, or by in-the-ground signaling devices or on locally placed devices on poles or on the traffic light itself, devices that generate signals that can be picked up by an appropriate receiver. The teachings of U.S. Pat. Nos. 7,308,247; 7,986,934 and 9,568,334 and the references cited therein are incorporated by reference herein.

There is nothing comparable that is available to systematically warn of hazardous locations to a rider on a bicycle or electric scooter.

### BRIEF SUMMARY OF THE INVENTION

The present invention provides an alarm that sounds when a rider on a bicycle or electric scooter is approaching a potentially dangerous location such as a nearby traffic light, school zone, or railway crossing for which either a GPS location is available or a signaling device is located to generate information about its presence. In one embodiment, an alarm is sounded any time such a location is being approached. In another embodiment, particularly applicable when the rider is on a phone call, an alarm is sounded only when the phone or other wireless communication device is in an active voice mode. In still another embodiment, when the potentially dangerous location is a traffic light, the alarm is sounded only when the traffic light is a red light or calculated to be red by the time the bicycle or electric scooter reaches the intersection controlled by the traffic light.

While the invention will be illustrated with respect to nearby traffic lights, school zones, and railway crossings, in still further embodiments, the invention can sound an alarm when other potentially hazardous locations are being approached, such as stop signs, yield signs, and bridges.

Bicycles and electric scooters of all kinds can be benefitted by the invention. “Bicycles” as used herein are preferably pedaled bicycles but can include electrically assisted or electrically driven bicycles. Electric scooters as used herein are preferably two-wheeled scooters but can include three-wheeled and four-wheeled scooters.

Information about the location of traffic lights, school zones, and railway crossings are available as GPS points, or by in the ground or on pole locally placed devices, that generate a signal that can be picked up by an appropriate receiver. The bicycle or electric scooter is fitted with a device that can receive such a signal. Some such devices are described in the aforementioned U.S. Patent Nos. 7,308,247; 7,986,934 and 9,568,334.

In a specific embodiment, a method is provided for improving safety for the rider of a bicycle or electric scooter fitted with a device that is capable of receiving a signal indicative of a potentially dangerous location, the method warning of the approach to such location, comprising exercising the following steps by means of as computer program:

(a) determining the current location of the bicycle or electric scooter;

(b) determining if the bicycle or electric scooter is moving

(c) obtaining the signal indicative of a potentially dangerous location;

(d) determining if the bicycle or electric scooter is within a predetermined distance from the potentially dangerous location; and

(e) sounding an alarm in response to determining that (i) the bicycle or electric scooter is within the predetermined distance, and (ii] the bicycle or electric scooter is moving.

In another specific embodiment, in which the rider of the bicycle or electric scooter is using a wireless communication device such as phone that has an active voice mode (i.e., he or she can talking and/or listen on the phone), a method is provided for improving safety for the rider of a bicycle or electric scooter fitted with a device that is capable of receiving a signal indicative of a potentially dangerous location, the method warning of the approach to such location, comprising exercising the following steps by means of as computer program:

(a) determining the current location of the bicycle or electric scooter;

(b) determining if the bicycle or electric scooter is moving

(c) obtaining the signal indicative of a potentially dangerous location;

(d) determining if the bicycle or electric scooter is within a predetermined distance from the potentially dangerous location;

(e) determining if the wireless communication device is in an active voice mode; and

(f) sounding an alarm in response to determining that (i) the bicycle or electric scooter is within the predetermined distance, (ii) the bicycle or electric scooter is moving, and (iii) the wireless communication device is in an active voice mode.

### BRIEF DESCRIPTION OF THE DRAWINGS

For a more complete understanding of the present invention, reference is now made to the following descriptions taken in conjunction with the accompanying drawing, in which:

FIG. 1 is a depiction of one embodiment of the invention in which a bicycle is fitted with a device that is responsive to a hazardous location signal and can issue an alarm;

FIG. 1A is depiction of a second embodiment of the invention in which the device is a wireless communication device and the bicycle of FIG. 1 is further equipped with a pair of buds that can be worn by the rider to receive a phone call via a wireless communication device enabling the rider to be in an active voice mode;

FIG. 2 is a depiction of a third embodiment of the invention in which an electric scooter is fitted with a device that is responsive to a hazardous location signal and can issue an alarm;

FIG. 2A is a depiction of a fourth embodiment of the invention in which the device is a wireless communication device and the electric scooter of FIG. 2 is further equipped with a pair of buds that can be worn by the rider to receive a phone call via a wireless communication device enabling the rider to be in an active voice mode;

FIG. 3 is a flow chart describing a sequence of steps to generate an alarm with the embodiments of FIGS. 1 and 2.

FIG. 4 is a flow chart describing a sequence of steps to generate an alarm with the embodiments of FIGS. 1A and 2A.

### DETAILED DESCRIPTION OF THE INVENTION

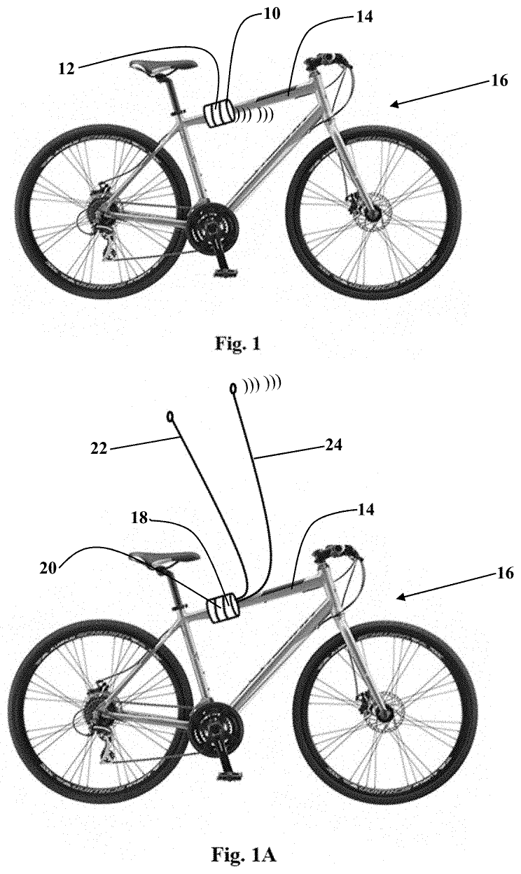

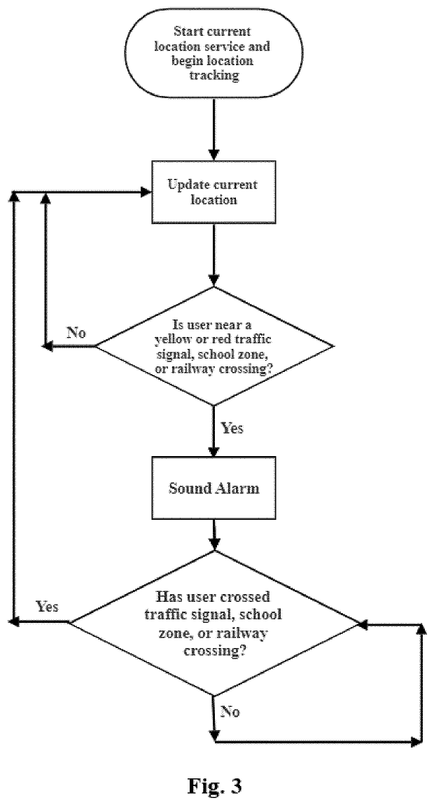

Referring to FIG. 1, a battery operated, programmable GPS enabled signal receiving device 10 is connected by a strap 12 to the cross bar 14 of a bicycle 16 but it can be secured to any convenient location on the bicycle. The strap 12 can carry mating hooks and loops, such as on a Velcro® strap. The device 10 can be any device that can receive and act on a signal representing a potentially hazard location, such as a nearby traffic light, school zone, or railway crossing, for which either a GPS location is available, or a device is located to generate information about its presence and transmits that location to be received by the signal receiving device 10. Such a signal receiving device 10 is exemplified by the cellular telephone described in U.S. Pat. No. 7,986,934 or by the wireless technology described as The Solution™ in the website of Global Mobile Alert at: https://www.globalmobilealert.com. Operation of the device of FIG. 1 is describe below with respect to FIG. 3.

The bicycle 16 of FIG. 1 can be any make, illustrated here by a Schwinn Phocus 1500; see https://www.schwinnbikes.com/en/int/bikes/hybrid/phocus-1500-s5490a. For a bicycle, by “nearby” or “near” is meant any distance from which the bicycle can safely stop before encountering the hazard, for example between 50 feet to 250 feet. The miles per hour at which the bicycle is traveling to indicate that it is moving is any movement that can be detected by the device, for example 3 miles per hour or more.

In addition to traffic lights, school zones, or railway crossing, potentially hazardous locations can be any such location for which a GPS or other signal is obtainable such as stop signs, yield signs, and bridges.

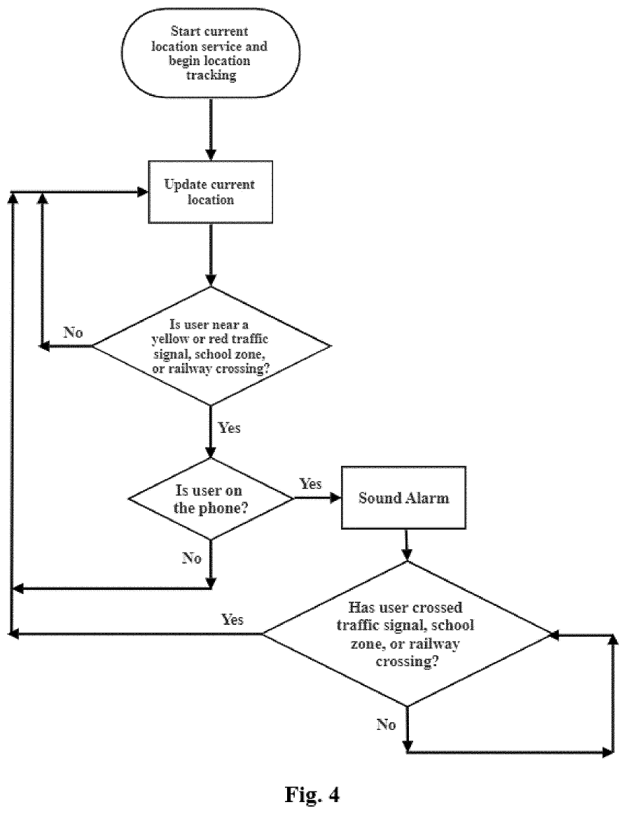

Referring to FIG. 1A a second embodiment of the invention is shown in which the device 18 is a wireless communication device is carried on the cross bar 14 by a strap 20 and the bicycle 16 of FIG. 1A is further equipped with a pair of buds 22 and 24 that can be worn by the rider to receive a phone call via the wireless communication device enabling the rider to be in an active voice mode. Operation of the device of FIG. 1A is describe below with respect to FIG. 4.

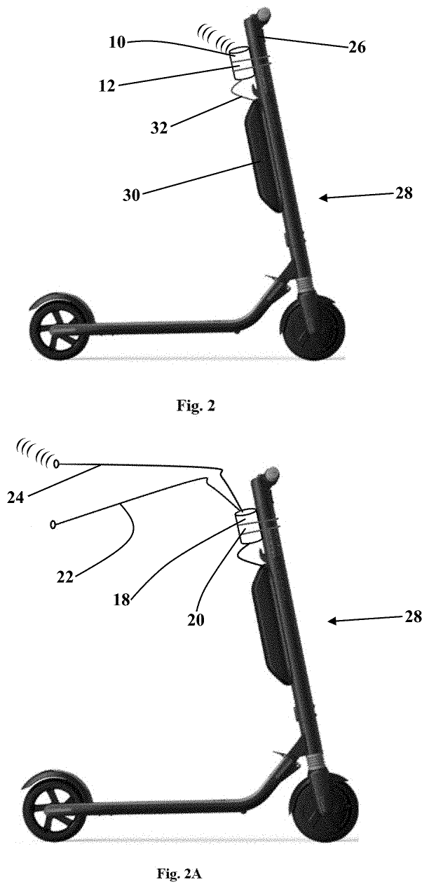

Referring to FIG. 2, a programmable GPS enabled signal receiving device 10 is connected by a strap 12 to the upright pole 26 of an electric scooter 28 but it can be secured to any convenient location on the scooter. Here too, the strap 12 can carryon mating hooks and loops, such as on a Velcro® strap. The device 10 can be any device that can receive a signal representing a potentially hazard location, such as a nearby traffic light, school zone, or railway crossing, for which either a GPS location is available, or a device is located to generate information about its presence and transmits that location to be received by the signal receiving device 10. As before, such a signal receiving device 10 is exemplified by the cellular telephone described in U.S. Pat. No. 7,986,934 or by the wireless technology describe as The Solution™ Operation of the device of FIG. 1 is describe below with respect to FIG. 3.

While the signal receiving device 10 is battery powered, since the electric scooter has its own power source 30, with accommodating modification to the power source, an electrical wire 32 can connect to the power source to provide electric power to the signal receiving device.

The electric scooter 28 of FIG. 2 can be any make, illustrated here by a Ninebot Segway-ES4 KickScooter®; see: https://store.segway.com/kickscooter-compare-list.

For an electric scooter, by “nearby” or “near” is meant any distance from which the electric scooter can safely stop before encountering the hazard, for example between 25 feet to 125 feet. The miles per hour at which the electric scooter is traveling to indicate that it is moving is any movement that can be detected by the device, for example 3 miles per hour or more.

Referring to FIG. 2A a second embodiment of the invention is shown in which the device 18 is a wireless communication device and the electric scooter 28 of FIG. 2A is further equipped, in the manner of the bicycle 16 of FIG. 1A, with a pair of buds 22 and 24 that can be worn by the rider to receive a phone call via the wireless communication device enabling the rider to be in an active voice mode. Operation of the device of FIG. 2A is describe below with respect to FIG. 4.

While the signal receiving device or wireless communication device have been illustrated as being strap on devices, the same functionality can be built in as part of the bicycle or electric scooter.

Referring to FIG. 3, a flow chart is provided describing a sequence of steps to generate an alarm with the embodiments of FIGS. 1 and 2. At the start, by turning on the device 10, a current location service is enabled to begin location tracking and update the current location. If the current location is not near a potential hazard, the current location continues to be updated until it is near a potentially hazard. When the location is near a potential hazard, an alarm is sounded. If the user has crossed the location of the potential hazard, the program returns to update the current location to wait for the next potential hazard. If the user has not yet crossed the location of the potential hazard, then no action is taken until the potential hazard has been crossed whereupon the program resumes updating the current location. The alarm can continuously sound while the user is moving and near the location of the potential hazard, or it can make a single alarm sound. The latter is preferred to limit an annoying continuation of the sound.

Referring to FIG. 4, a flow chart is provided describing a sequence of steps to generate an alarm with the embodiments of FIGS. 1A and 2A. It is similar to the flow chart of FIG. 3, but before the alarm is sounded, the program determines whether the wireless communication device is in an active voice mode, i.e., the user is on the phone. Only then is the alarm sounded. Whereas in the procedure of FIG. 3, an alarm is sounded whenever the user approaches the potentially hazard location, which can be annoying to the point that the user eventually becomes immune to, and ignores, the alarm. By limiting the sounding of the alarm to those instances when a user is in active voice mode, a warning is sounded only when the user is being seriously distracted with the result that the user does not get immune to the sound of the alarm.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims

1. A method for improving safety for the rider on a bicycle or electric scooter, comprising:
fitting the bicycle or electric scooter with a device that is capable of receiving a signal indicative of a potentially dangerous location, the method warning of the approach to such location, comprising exercising the following steps by means of as computer program:
(a) determining the current location of the bicycle or electric scooter;
(b) determining if the bicycle or electric scooter is moving
(c) obtaining the signal indicative of a potentially dangerous location consisting essentially of a traffic light, a school zone, a railway crossing, a stop sign, a yield sign, or a bridge;
(d) determining if the bicycle or electric scooter is within a predetermined distance from the potentially dangerous location; and
(e) sounding an alarm in response to determining that (i) the bicycle or electric scooter is within the predetermined distance, and (iii the bicycle or electric scooter is moving.

2. (canceled)

3. The method of claim 1 in which the potentially dangerous location is a traffic light.

4. The method of claim 3 that including the step of determining if the traffic light is a red light or is calculated to be red by the time the bicycle or electric scooter reaches the traffic light.

5. The method of claim 1 in which the rider is on a bicycle.

6. The method of claim 1 in which the rider is on an electric scooter.

7. The method of claim 1 in which the device capable of receiving a signal indicative of a potentially dangerous location is a communication device having an active voice mode.

8. The method of claim 7 including the step of determining that communication device is in an active voice mode before sounding the alarm.

9. The method of claim 1 in which the device capable of receiving a signal is fitted on the bicycle or electric scooter by a flexible strap having hooks on one side of the strap and loops on the other side of the strap.

10. A method for improving safety for the rider on a bicycle or electric scooter, comprising:
fitting the bicycle or electric scooter with a communication device having an active voice mode and that is capable of receiving a signal indicative of a potentially dangerous location, the method warning of the approach to such location, comprising exercising the following steps by means of as computer program:
(a) determining the current location of the bicycle or electric scooter;
(b) determining if the bicycle or electric scooter is moving
(c) obtaining the signal indicative of a potentially dangerous location consisting essentially of a traffic light, a school zone, a railway crossing, a stop sign, a yield sign, or a bridge;
(d) determining if the bicycle or electric scooter is within a predetermined distance from the potentially dangerous location;
(e) determining if the communication device is in an active voice mode; and
(I) sounding an alarm in response to determining that (i) the bicycle or electric scooter is within the predetermined distance, (ii) the bicycle or electric scooter is moving, and (iii) the communication device is in an active voice mode.

11. (currently canceled)

12. The method of claim 10 in which the potentially dangerous location is a traffic light.

13. The method of claim 12 that including the step of determining if the traffic light is a red light or is calculated to be red by the time the bicycle or electric scooter reaches the traffic light.

14. The method of claim 10 in which the rider is on a bicycle.

15. The method of claim 10 in which the rider is on an electric scooter.

16. The method of claim 10 in which the device capable of receiving a signal is fitted on the bicycle or electric scooter by a flexible strap having hooks on one side of the strap and loops on the other side of the strap.

17. The method of claim 6 including a power source on or in the electric scooter, the power source being electrically connected to the communication device.

18. The method of claim 15 including a power source on or in the electric scooter, the power source being electrically connected to the communication device.
